(19) United States
(12) Patent Application Publication
(10) Pub. No.: US 2025/0131202 A1
(43) Pub. Date: Apr. 24, 2025

(54) PROVIDING AND MANAGING AN AUTOMATED AGENT

(71) Applicant: Scaled Cognition, Inc., Amesbury, MA (US)

(72) Inventors: Adam Pauls, Berkeley, CA (US); Mathew Gardner, Irvine, CA (US); Emmanoiul Anthony Platanios, Fremont, CA (US); Mitchell Stern, Berkeley, CA (US); Daniel Klein, Berkeley, CA (US); Marco DiPlacido, Cambridge, MA (US)

(73) Assignee: Scaled Cognition, Inc., Amesbury, MA (US)

(21) Appl. No.: 18/388,534

(22) Filed: Nov. 10, 2023

Related U.S. Application Data
(60) Provisional application No. 63/545,172, filed on Oct. 21, 2023.

(51) Int. Cl. G06F 40/40; G06N 3/08; G06Q 30/015

(52) U.S. Cl. CPC G06F 40/40; G06N 3/08; G06Q 30/015

(57) ABSTRACT

A system for providing and managing an automated agent. The automated agent may interact with a customer and utilize rules and instructions to determine a response to the customer and actions to perform. The customer interactions by the automated agent are driven by a set and/or subset of instructions that can be analyzed before each automated agent response or action. The subset of instructions, customer conversational input, and other content can be processed by a machine learning model, which may be implemented as a large language model (LLM).

### CROSS REFERENCE TO RELATED APPLICATIONS

The present application claims the priority benefit of U.S. provisional patent application 63/545,172, filed on Oct. 21, 2023, titled “Providing and Managing an Automated Agent,” the disclosure of which is incorporated herein by reference.

### BACKGROUND

As online applications continue to develop, automated assistant applications are becoming more popular. To provide an automated agent, a set of rules is typically applied to conversational content between the automated agent and a user. The rules set can be extensive, and it can be difficult to determine exactly which rules are applicable to the requests of a user. What is needed is an improved way of developing an automated assistant.

### SUMMARY

The present technology, roughly described, provides a system for providing and managing an automated agent. The automated agent may interact with a customer and utilize rules and instructions to determine a response to the customer and actions to perform. The customer interactions by the automated agent are driven by a set and/or subset of instructions that can be analyzed before each automated agent response or action. The subset of instructions, customer conversational input, and other content can be processed by a machine learning model.

In some instances, the machine learning (ML) model may be implemented as a large language model (LLM). The processed training materials are submitted within a prompt, along with role information and instruction information. The role may indicate the role of the automated agent that will follow the extracted instructions output by the machine learning model. The instructions included in the prompt may direct the machine learning model to find relevant instructions from the provided learning materials.

The LLM processes the prompt and outputs extracted instructions based on the prompt content. In some instances, the LLM processes customer conversation content and a set of instructions to determine if the instructions are relevant to a customer request. By determining whether the instructions are relevant or not, the system automatically reduces the time required to process instructions and increases the likelihood of following the correct instructions. In some instances, in place of or in addition to identifying relevant instructions, an LLM can process customer conversation content and a set of instructions to determine what action to take based on a customer request.

In some instances, the present technology performs a method for providing an automated agent. The method beings with receiving an inquiry from a customer by an automated agent on a first server. Instructions are retrieved based on the inquiry, and for the automated agent, from a remote data store. A first machine learning model can then determine which of the retrieved instructions are relevant to the inquiry. The inquiry, the instructions, and a role are provided to a second machine learning model, wherein the role indicates a service level associated with the automated agent. A response is then provided to the customer by the automated agent based on a response by the second machine learning model.

In some instances, the present technology includes a non-transitory computer readable storage medium having embodied thereon a program, the program being executable by a processor to creating automated agent instructions from training materials. The method beings with receiving an inquiry from a customer by an automated agent on a first server. Instructions are retrieved based on the inquiry, and for the automated agent, from a remote data store. A first machine learning model can then determine which of the retrieved instructions are relevant to the inquiry. The inquiry, the instructions, and a role are provided to a second machine learning model, wherein the role indicates a service level associated with the automated agent. A response is then provided to the customer by the automated agent based on a response by the second machine learning model.

In some instances, the present technology includes a system having one or more servers, each including memory and a processor. One or more modules are stored in the memory and executed by one or more of the processors to receive an inquiry from a customer by an automated agent on a first server, retrieving instructions, based on the inquiry, for the automated agent from a remote data store, determine, by a first machine learning model, which of the retrieved instructions are relevant to the inquiry, provide the inquiry, the instructions, and a role to a second machine learning model, the role indicating a service level associated with the automated agent, provide a response to the customer by the automated agent based on a response by the second machine learning model.

### BRIEF DESCRIPTION OF FIGURES

FIG. 1 is a block diagram of a system providing an intelligent automated agent.

FIG. 2 is a block diagram of a prompt.

FIG. 3 is a block diagram of a machine learning model.

FIG. 4 is a block diagram of an application.

FIG. 5 is a method for providing an intelligent automated agent.

FIG. 6 is a method for generating a prompt.

FIG. 7 illustrates a method for generating a prompt.

FIG. 8 is a method for assembling instructions for a prompt.

FIG. 9 is a method for performing an audit of a conversation between an automated agent in a customer.

FIG. 10 illustrates a method for generating a customer service application.

FIG. 11 is a block diagram of a computing environment for implementing the present technology.

### DETAILED DESCRIPTION

The present technology, roughly described, provides a system for providing and managing an automated agent. The automated agent may interact with a customer and utilize rules and instructions to determine a response to the customer and actions to perform. The customer interactions by the automated agent are driven by a set and/or subset of instructions that can be analyzed before each automated agent response or action. The subset of instructions, customer conversational input, and other content can be processed by a machine learning model.

In some instances, the machine learning (ML) model may be implemented as a large language model (LLM). The processed training materials are submitted within a prompt, along with role information and instruction information. The role may indicate the role of the automated agent that will follow the extracted instructions output by the machine learning model. The instructions included in the prompt may direct the machine learning model to find relevant instructions from the provided learning materials.

The LLM processes the prompt and outputs extracted instructions based on the prompt content. In some instances, the LLM processes customer conversation content and a set of instructions to determine if the instructions are relevant to a customer request. By determining whether the instructions are relevant or not, the system automatically reduces the time required to process instructions and increases the likelihood of following the correct instructions. Put another way, the system makes it feasible to follow the correct instructions. In some instances, in place of or in addition to identifying relevant instructions, an LLM can process customer conversation content and a set of instructions to determine what action to take based on a customer request.

The LLM can also process conversations between a customer and an automated agent and instructions associated with the conversation to determine if the automated agent followed the instructions correctly. This automatic auditing of a conversation to determine if instructions were correctly followed saves valuable time previously spent by humans in reviewing previous conversations with errors. If an error is found, the action by the audited automated agent is flagged, the instructions are updated or corrected, and a new response can be generated. Additionally, the updated instructions can be properly followed in subsequent situations.

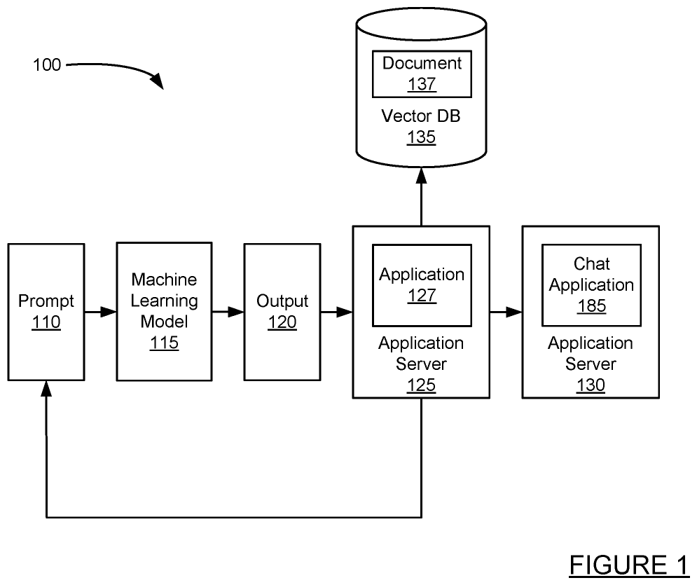

FIG. 1 is a block diagram of a system for providing an intelligent automated agent. System 100 of FIG. 1 includes prompt 110, machine learning model 115, output 120, application server 125, vector database 135, and application server 130.

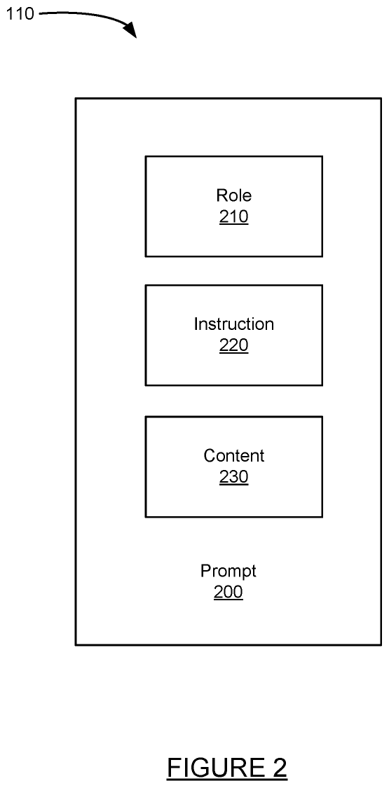

A prompt 110 is generated by the present system, for example by application 127 of application server 125, and used as an input to machine learning model 115. Prompt 110 may include information identifying a role, prompt instructions relating to what the machine learning model should do, and content. The role within a prompt can be specified as one or more of a front-line customer service representative, a supervisor, an IT technician, or other role. The content can be derived from instructions retrieved from vector database 135, an output of machine learning model 115, at least a portion of a conversation between an automated agent 135 and a user, or some other source of content. An exemplary prompt 110 is discussed in more detail with respect to FIG. 2.

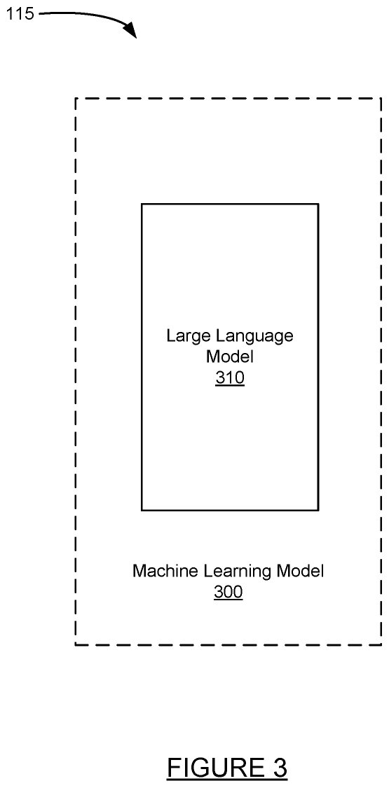

Machine learning model 115 may receive prompt 110, process the prompt, and provide an output 120. In some instances, machine learning model 115 may be implemented as a large language model. The LLM may receive and process the prompt, along with a request and other data, to solve a request. In some instances, the prompt can include instructions to identify the most relevant instructions within the prompt. In response, the machine learning model may process the prompt, identify the most relevant instructions, and provide the most relevant instructions as output 120. In some instances, the prompt content can include instructions to provide the first step, or next step, in determining a solution to a request received from a user. The request may be received within a conversation between the user and an automated agent. In some instances, the prompt content can include at least a portion of a conversation between an automated agent and a user. Machine learning model 115 is discussed in more detail with respect to FIG. 3.

Output 120 is provided by machine learning model 115 in response to processing prompt 110. For example, when the prompt includes a request that the machine learning model identify the most relevant instructions from a set of content, the output will include a list of the most relevant instructions. In some instances, when the prompt includes a request that the machine learning model determine if an automated agent properly followed a set of instructions during a conversation with a user, the machine learning model may return a confidence score, prediction, or other indication as to whether the instructions were followed correctly by the automated agent.

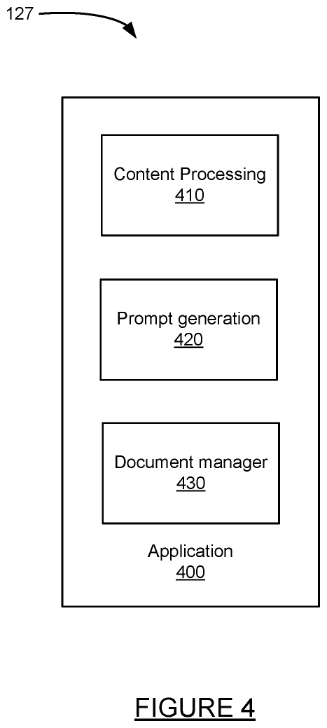

Application server 125 includes application 127 and receives output 120 from machine learning model 115. Upon receiving the output, application 127 may process the output and provide it to vector database 135. Application 127 may process the output by storing relevant instructions, identifying correctly followed instructions, and creating one or more documents 137. Document 137 may then be stored at vector database 135. Application 127 is discussed in more detail with respect to FIG. 4.

Vector database 135 may be implemented as a data store that stores vector data. In some instances, vector database 135 may be implemented as more than one data store, internal to system 103 and exterior to system 103. In some instances, a vector database can serve as an LLMs' long-term memory and expand an LLMs' knowledge bases. Vector database 135 can store private data or domain-specific information outside the LLM as embeddings. When a user asks a question to an administrative assistant, the system can have the vector database search for the top results most relevant to the received question. Then, the results are combined with the original query to create a prompt that provides a comprehensive context for the LLM to generate more accurate answers.

Once instructions for an automated agent are stored in document 167 at vector database 135, an automated agent 135 may be implemented on application server 130. The automated agent 135 may operate as an automated customer service agent and engage in conversations with users. When a user asks a query, automated agent 135 may process a query, at least in part, by initiating a search for instructions from document 167, submission of the instructions to a machine learning model, and then eventually providing a response to the user.

In some instances, machines that implement one or more of 110, 115, 120, 125, 130, and 135 may be implemented within a single system, and may communicate with each other, and other machines, over one or more networks. The networks may include private networks, public networks, a LAN, a WAN, the Internet, an intranet, a wireless network, a Wi-Fi network, a cellular network, a fiber-optic network, a combination of these networks, or some other network that is capable of communicating data. In some instance, one or more of these networks may be implemented within system 103, as well as between system 103 and the machines illustrated outside the system in FIG. 1.

In some instances, one or more of machines associated with 110, 115, 120, 125, 130 and 135 may be implemented in one or more cloud-based service providers, such as for example AWS by Amazon Inc, AZURE by Microsoft, GCP by Google, Inc., Kubernetes, or some other cloud based service provider.

FIG. 2 is a block diagram of a prompt. Prompt 200 of FIG. 2 provides more detail for prompt 110 of the system of FIG. 1. Prompt 200 may include text to provide as input to a machine learning model 115. The text may include information about a role 210, instructions 220 for generating an output, and content 230. In some instances, the prompt may include instructions that state the machine learning model is to select as the most relevant instructions from the content 230 to train a customer service representative having specified role 210. The content 230 may include instructions previously retrieved or accessed, for example from vector DB 135. The retrieved instructions may be within document 137. In some instances, the content 230 in a prompt 200 may include only a portion of a particular type of processed training material, to fit within the character or size restraints of the particular machine learning model, and the entire training materials would be submitted in two or more prompts.

FIG. 3 is a block diagram of a machine learning model. The machine learning model 300 of FIG. 3 provides more detail for machine learning model 115 of the system of FIG. 1. The machine learning model 300 may be implemented by a large language model 310. A large language model is a machine learning model that uses deep learning algorithms to process and understand language. LLMs can have an encoder, a decoder, or both, and can encode positioning data to their input. In some instances, LLMs can be based on transformers, which have a neural network architecture, and have multiple layers of neural networks. An LLM can have an attention mechanism that allows them to focus selectively on parts of text. LLMs are trained with large amounts of data and can be used for different purposes.

The transformer model learns context and meaning by tracking relationships in sequential data. LLMs receive text as an input through a prompt and provide a response to one or more instructions. For example, an LLM can receive a prompt as an instruction to analyze data. The prompt can include a context (e.g., a role, such as ‘you are an agent’), a bulleted list of itemized instructions, and content to apply the instructions to.

In some instances, the present technology may use an LLM such as a BERT LLM, Falcon 30B on GitHub, Galactica by Meta, GPT03 by OpenAI, or other LLM. In some instances, machine learning model 115 may be implemented by one or more other models or neural networks.

FIG. 4 is a block diagram of an application. Application 400 of FIG. 4 provides more detail for application 127 of FIG. 1. Application 400 includes content processing 410, prompt generation 420, and document manager 430. Content processing 410 may perform audio to text conversion, graphics to text conversion, text parsing, text editing, and can select content for inclusion into prompt 110. In some instances, content processing 410 may perform at least some or all of the same functions as processing 145.

Prompt generation 420 may generate a prompt as input to machine learning model 115. The prompt may include role information, instructions, and content such as a conversation between an automated agent and a customer, a larger set of instructions, and other content.

Document manager 430 may generate document 167, which is stored in vector database 135. Document manager 430 may receive outputs from machine learning model 115, summarize the instructions within the outputs, store the outputs in a document, and store document 167 within vector database 135.

The modules illustrated in application 400 are exemplary, can be implemented in more or fewer modules than those illustrated in FIG. 4. Additionally, application 400 can implement other functionality described herein.

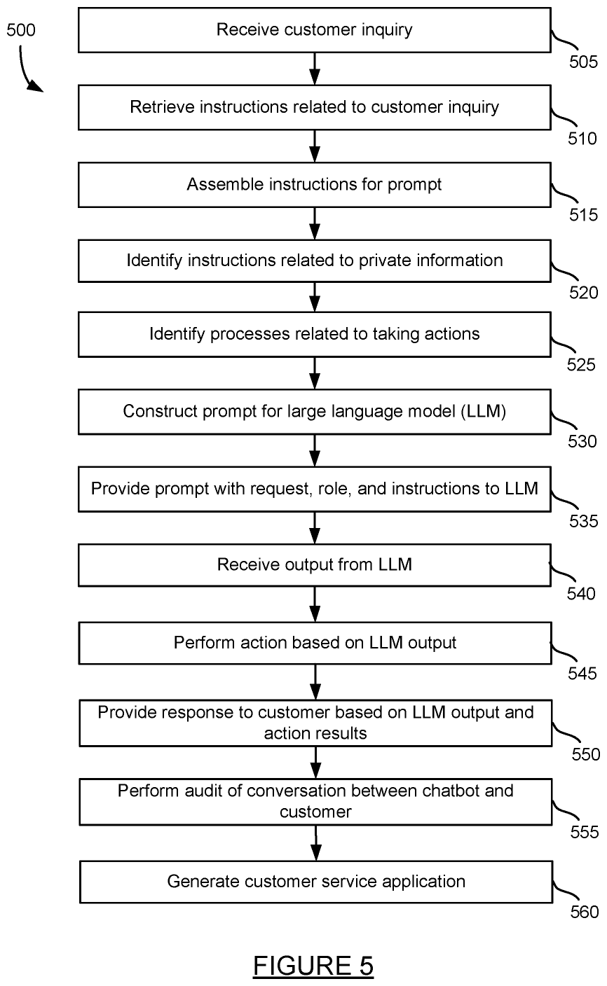

FIG. 5 illustrates a method 500 for providing an intelligent automated agent. First, a customer inquiry is received at step 505. The inquiry may be received from a human customer, a computing system, or other customer within a conversation with an automated agent provided by the present system. The inquiry may be related to a field associated with the automated agent and system 100. For example, the inquiry could be about booking airfare for the airline industry, about booking a car for a car rental agency, about a medical appointment for the medical field, and so forth. The conversation between the agent and the customer may be hosted and managed by the system of FIG. 1.

Instructions related to the customer inquiry are retrieved at step 510. In some instances, application 127 may retrieve instructions related to the customer query from vector database 135. Retrieving instructions may include application 127 generating a query vector based on the customer inquiry received through a conversation with the present system, transmitting the query vector to vector database 135, and the vector database receiving and processing the query vector. Processing the query vector may include selecting the instructions that are determined to be closest or most similar to the query vector. The vector database may then transmit the selected instructions back to application 127.

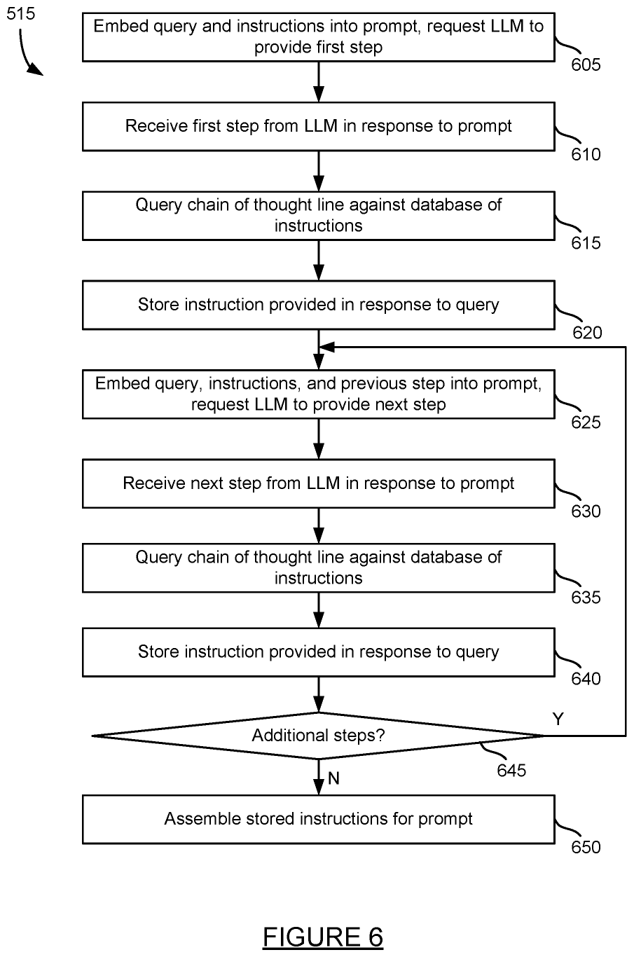

After retrieving the instructions, the instructions are assembled for use in a prompt at step 515. In some instances, the instructions for processing the customer query may cover the processing of the customer inquiry from beginning to end. In some instances, the instructions may be retrieved to process the first step of solving the customer's inquiry, and each step thereafter towards satisfying the customer inquiry, one step at a time. More details for processing a customer inquiry with instructions, one step at a time, are discussed with respect to the method of FIG. 6.

Instructions related to private information may be identified at step 520. In some instances, private information should be kept away from a customer in a conversation with an automated agent of the present system. As such, instructions related to private information, or private information that might be given in a response to the customer and query, are marked to ensure that they are not provided to a customer. Processes related to taking actions are then identified at step 525. Processes related to taking actions may include a number of steps required to perform a single action, such as identifying a city of departure and a city of arrival for scheduling a flight.

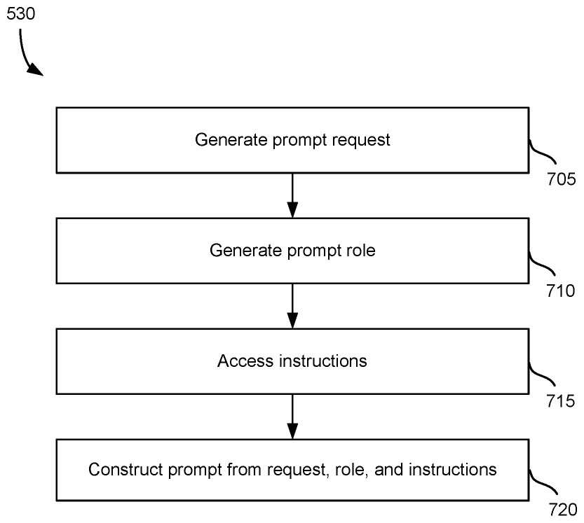

A prompt is constructed for a large language model at step 530. The prompt may include a role, instructions, and a request. The prompt may be provided to the LLM with the request, role, and instructions at step 535. Constructing a prompt is discussed in more detail with respect to the method FIG. 7.

An output may be received from the LLM at step 540. An action may be performed based on the LLM output at step 545. The action may include retrieving information from an external service, or some other output. A response is provided to a customer based on an LLM output and the action results at step 550. The response may include data requested by the customer, results of the action performed at step 545, or some other response.

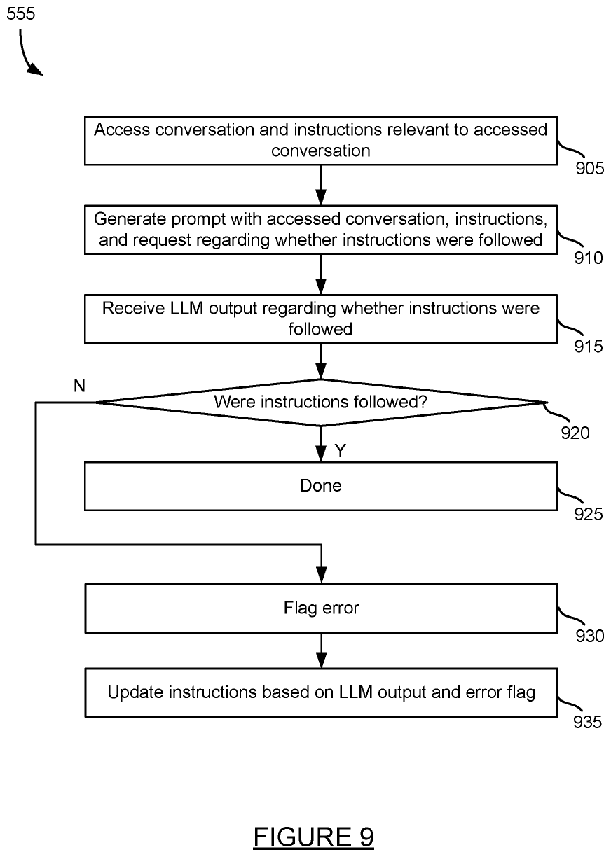

In some instances, after a conversation between an automated agent in a customer has transpired and is either complete or has been ongoing for a period of time, an audit may be performed of the conversation at step 555. The audit may include reviewing instructions and rules followed by the automated agent to ensure they were correct. More details for performing an audit of a conversation between an automated agent and a customer is discussed with respect to the method of FIG. 9.

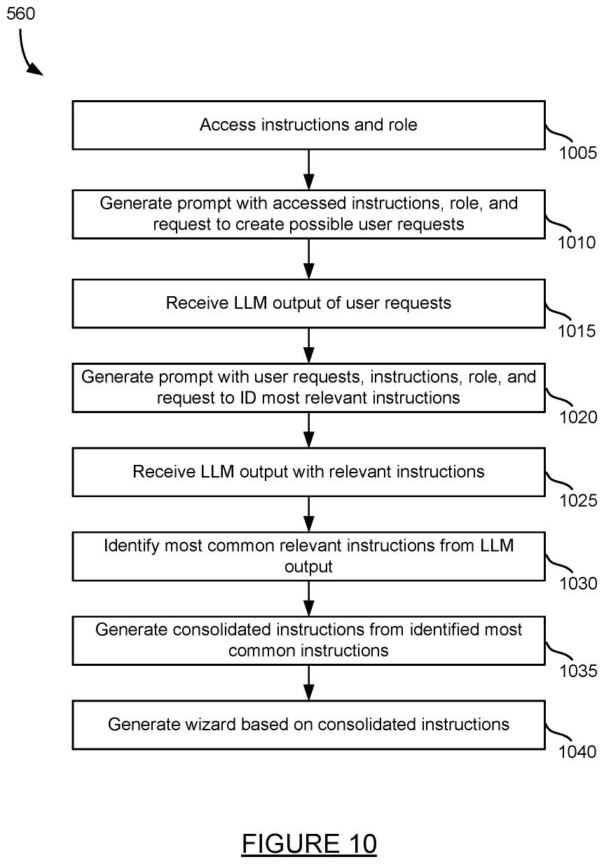

A customer service application may be generated at step 560. In some instances, the most common scenarios handled by the automated agent are identified, and the customer service application is generated to handle those most common scenarios. More details for generating a customer service application is discussed with respect to the method of FIG. 10.

FIG. 6 is a method for assembling instructions for a prompt. In some instances, an LLM may be used to process a request one step at a time rather than be requested to provide a single and final answer to an inquiry. The method of FIG. 6 utilizes an LLM to identify relevant instructions, one step at a time. The method of FIG. 6 provides more detail for step 515 of the method of FIG. 5.

First, a query and instructions are embedded into a prompt, and a request is sent to an LLM to provide a first step at step 605. The first step is received from the LLM in response to the prompt at step 610. The first step in the chain of thought is queried against the database of instructions at step 615. Instructions provided in response to a query are then stored at step 620.

Query instructions and the previous step are embedded into a prompt, and the prompt is sent to the LLM with a request to provide the next step at 625. The next step is received from the LLM in response to the prompt at step 630. The next step in the chain of thought is queried against a database of instructions at step 635. Instructions provided in response to the query are then stored at step 640.

A determination is made as to whether there are any additional steps at step 645. If there are additional steps, the method continues to step 825 where the next step is embedded in a prompt and submitted to an LLM. If there are no additional steps, the stored instructions are assembled for a prompt to an LLM at step 650.

FIG. 7 illustrates a method for generating a prompt. The method of FIG. 7 provides more detail for step 530 of the method of FIG. 5.

First, a prompt request is generated at step 705. The prompt request may indicate what the LLM is requested to do, such as identify relevant instructions, determine if instructions were followed, or some other request. A prompt role is generated at step 710. The role indicates the clearance or permissions of the automated agent, and can be used to help indicate what instructions are relevant to the particular task to which an LLM is processing. Instructions are then accessed at step 715. Instructions are used to indicate to the LLM what the LLM is supposed to achieve, with any boundaries, limitations, variables, and so forth. The prompt is then constructed from the request, the role, and instructions at step 720.

In some instances, additional checks or audits can be performed for one or more instructions to confirm if instructions received from a vector database are relevant. For example, a list of instructions can be submitted to an LLM with a request to confirm if the instructions are relevant for a particular request.

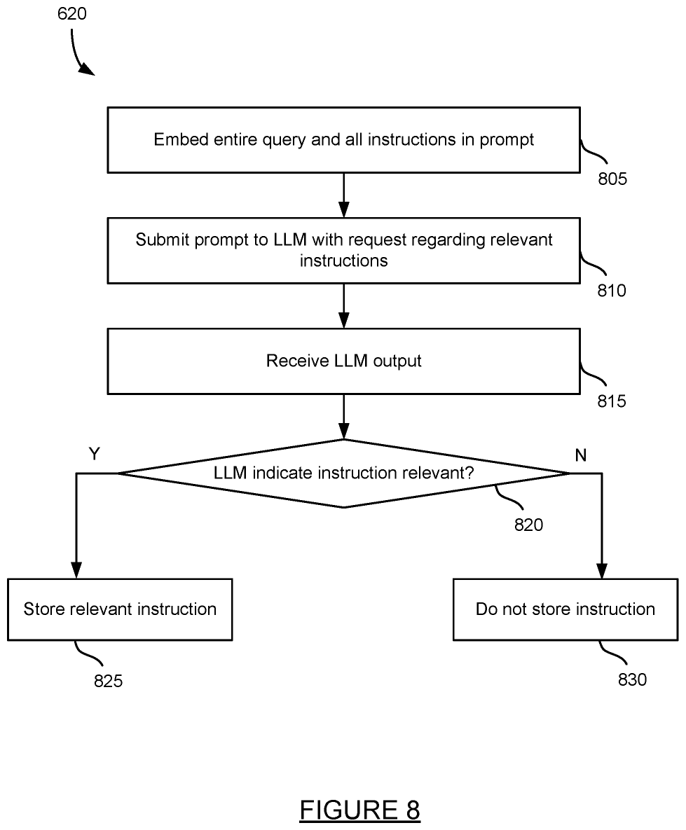

FIG. 8 is a method for assembling instructions for a prompt. The instructions are assembled after determining if they are relevant. First, an entire query with all instructions are embedded in a prompt at step 805. The prompt is then submitted to an LLM with a request that indicates the LLM should identify which instructions are relevant at step 810. The request can include a user inquiry, automated agent role, and other content.

The output of the LLM is received at step 815. A determination is then made as to whether the LLM indicated one or more of instructions are relevant at step 820. If the instructions submitted to the LLM through the prompt are determined to be relevant by the LLM as indicated in the LLM output, the relevant instructions are stored at step 825. If any instructions are determined to not be relevant, the non-relevant instructions are not stored at step 830.

FIG. 9 is a method for performing an audit of a conversation between an automated agent in a customer. The method of FIG. 9 provides more detail for step 555 of the method of FIG. 5. First, a conversation and instructions relevant to the access conversation are accessed at step 905. A prompt is generated at step 910. Generated prompt includes the access conversation, instructions, and a request as to whether the instructions were followed. The prompt is provided to the LLM, and an LLM output is received regarding whether the instructions were properly followed at step 915. A determination is made as to whether the instructions were followed at step 920. If the instructions were followed, the audit process for those particular instructions is complete at step 925. If the instructions were not followed properly, and error is flagged at step 930, and instructions are updated based on the LLM output and the air flag at step 935. The method of FIG. 9 is provided for each set of instructions within a conversation between an automated agent in a customer.

FIG. 10 illustrates a method for generating a customer service application. The method of FIG. 10 provides more detail for step 560 and the method of FIG. 5. First, instructions on a roll are accessed at step 1005. A prompt is then generated at step 1010. The prompt is generated with the access instructions, role data, and request to create possible user requests at step 1010. The number of possible user request may be hundred, thousand, or more. The LM output of possible user request is then received at step 1015. A prompt is then generated with the user request, instructions, role, and request to identify the most relevant instructions related to the output user requests at step 1020. The generated prompt is provided to an LM, and an LLM output is received with the relevant instructions at step 1025. The most common relevant instructions from the LLM output are identified at step 1030. The most common relevant instructions may include the top 10%, 20%, or 30% of instructions repeatedly retrieved to process the user request output. The consolidated instructions from the identified most, instructions generated at step 1035. A wizard may then be generated based on the consolidated instructions at step 1040. The wizard would only address the most common instructions retrieved to handle the user request output.

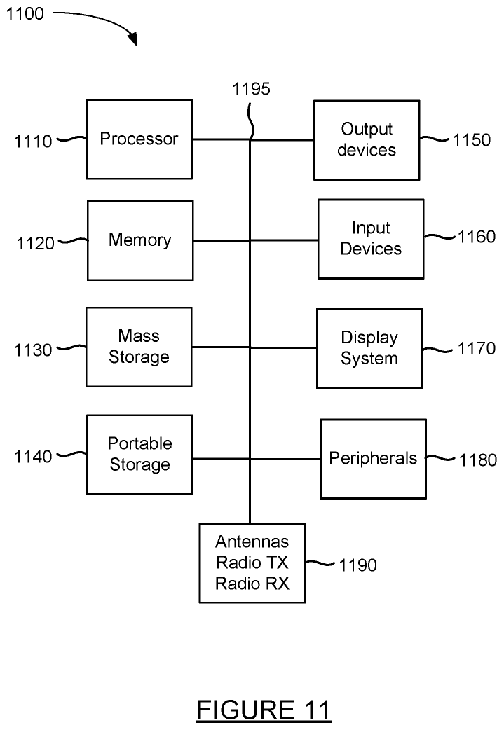

FIG. 11 is a block diagram of a computing environment for implementing the present technology. System 1100 of FIG. 11 may be implemented in the contexts of the likes of machines that implement machine learning model 115, application server 125, and application server 130. The computing system 1100 of FIG. 11 includes one or more processors 1110 and memory 1120. Main memory 1120 stores, in part, instructions and data for execution by processor 1110. Main memory 1120 can store the executable code when in operation. The system 1100 of FIG. 11 further includes a mass storage device 1130, portable storage medium drive(s) 1140, output devices 1150, user input devices 1160, a graphics display 1170, and peripheral devices 1180.

The components shown in FIG. 11 are depicted as being connected via a single bus 1195. However, the components may be connected through one or more data transport means. For example, processor unit 1110 and main memory 1120 may be connected via a local microprocessor bus, and the mass storage device 1130, peripheral device(s) 1180, portable storage device 1140, and display system 1170 may be connected via one or more input/output (I/O) buses.

Mass storage device 1130, which may be implemented with a magnetic disk drive, an optical disk drive, a flash drive, or other device, is a non-volatile storage device for storing data and instructions for use by processor unit 1110. Mass storage device 1130 can store the system software for implementing embodiments of the present invention for purposes of loading that software into main memory 1120.

Portable storage device 1140 operates in conjunction with a portable non-volatile storage medium, such as a floppy disk, compact disk or Digital video disc, USB drive, memory card or stick, or other portable or removable memory, to input and output data and code to and from the computer system 1100 of FIG. 11. The system software for implementing embodiments of the present invention may be stored on such a portable medium and input to the computer system 1100 via the portable storage device 1140.

Input devices 1160 provide a portion of a user interface. Input devices 1160 may include an alpha-numeric keypad, such as a keyboard, for inputting alpha-numeric and other information, a pointing device such as a mouse, a trackball, stylus, cursor direction keys, microphone, touch-screen, accelerometer, and other input devices. Additionally, the system 1100 as shown in FIG. 11 includes output devices 1150. Examples of suitable output devices include speakers, printers, network interfaces, and monitors.

Display system 1170 may include a liquid crystal display (LCD) or other suitable display device. Display system 1170 receives textual and graphical information and processes the information for output to the display device. Display system 1170 may also receive input as a touch-screen.

Peripherals 1180 may include any type of computer support device to add additional functionality to the computer system. For example, peripheral device(s) 1180 may include a modem or a router, printer, and other device.

The system of 1100 may also include, in some implementations, antennas, radio transmitters and radio receivers 1190. The antennas and radios may be implemented in devices such as smart phones, tablets, and other devices that may communicate wirelessly. The one or more antennas may operate at one or more radio frequencies suitable to send and receive data over cellular networks, Wi-Fi networks, commercial device networks such as a Bluetooth device, and other radio frequency networks. The devices may include one or more radio transmitters and receivers for processing signals sent and received using the antennas.

The components contained in the computer system 1100 of FIG. 11 are those typically found in computer systems that may be suitable for use with embodiments of the present invention and are intended to represent a broad category of such computer components that are well known in the art. Thus, the computer system 1100 of FIG. 11 can be a personal computer, handheld computing device, smart phone, mobile computing device, tablet computer, workstation, server, minicomputer, mainframe computer, or any other computing device. The computer can also include different bus configurations, networked platforms, multi-processor platforms, etc. The computing device can be used to implement applications, virtual machines, computing nodes, and other computing units in different network computing platforms, including but not limited to AZURE by Microsoft Corporation, Google Cloud Platform (GCP) by Google Inc., AWS by Amazon Inc., IBM Cloud by IBM Inc., and other platforms, in different containers, virtual machines, and other software. Various operating systems can be used including UNIX, LINUX, WINDOWS, MACINTOSH OS, CHROME OS, IOS, ANDROID, as well as languages including Python, PHP, Java, Ruby, .NET, C, C++, Node.JS, SQL, and other suitable languages.

The foregoing detailed description of the technology herein has been presented for purposes of illustration and description. It is not intended to be exhaustive or to limit the technology to the precise form disclosed. Many modifications and variations are possible in light of the above teaching. The described embodiments were chosen to best explain the principles of the technology and its practical application to thereby enable others skilled in the art to best utilize the technology in various embodiments and with various modifications as are suited to the particular use contemplated. It is intended that the scope of the technology be defined by the claims appended hereto.

1. A method for providing an automated agent, comprising:
receiving an inquiry from a customer by an automated agent on a first server;
retrieving instructions, based on the inquiry, for the automated agent from a remote data store;
determining, by a first machine learning model, which of the retrieved instructions are relevant to the inquiry;
providing the inquiry, the instructions, and a role to a second machine learning model, the role indicating a service level associated with the automated agent;
providing a response to the customer by the automated agent based on a response by the second machine learning model.

2. The method of claim 1, wherein the instructions are received from a vector database.

3. The method of claim 1, wherein the first machine learning model is a large language model.

4. The method of claim 3, wherein determining which of the retrieved instructions are relevant further includes:
constructing a prompt with the instructions, the inquiry, and a request to identify which of the retrieved instructions are relevant to satisfying the query; and
submitting the prompt to a large language model.

5. The method of claim 4, wherein the instructions provided to the second machine learning model are instructions determined to be relevant by the first large language model.

6. The method of claim 1, wherein the inquiry, the instructions, and the role are provided to the second machine learning model as prompt, the method further including:
providing a plurality of prompts to the second large language model, each of the prompts including the inquiry, the instructions, the role, and a request to provide a single step in the process of solving the inquiry, the number of prompts sent to the second machine learning model equal to the number of steps required by the second machine learning model to solve the inquiry.

7. The method of claim 1, wherein the instructions are automatically generated from training materials.

8. A non-transitory computer readable storage medium having embodied thereon a program, the program being executable by a processor to perform a method for providing an automated agent, the method comprising:
receiving an inquiry from a customer by an automated agent on a first server;
retrieving instructions, based on the inquiry, for the automated agent from a remote data store;
determining, by a first machine learning model, which of the retrieved instructions are relevant to the inquiry;
providing the inquiry, the instructions, and a role to a second machine learning model, the role indicating a service level associated with the automated agent;
providing a response to the customer by the automated agent based on a response by the second machine learning model.

9. The non-transitory computer readable storage medium of claim 8, wherein the instructions are received from a vector database.

10. The non-transitory computer readable storage medium of claim 8, wherein the first machine learning model is a large language model.

11. The non-transitory computer readable storage medium of claim 10, wherein determining which of the retrieved instructions are relevant further includes:
constructing a prompt with the instructions, the inquiry, and a request to identify which of the retrieved instructions are relevant to satisfying the query; and
submitting the prompt to a large language model.

12. The non-transitory computer readable storage medium of claim 11, wherein the instructions provided to the second machine learning model are instructions determined to be relevant by the first large language model.

13. The non-transitory computer readable storage medium of claim 8, wherein the inquiry, the instructions, and the role are provided to the second machine learning model as prompt, the method further including:
providing a plurality of prompts to the second large language model, each of the prompts including the inquiry, the instructions, the role, and a request to provide a single step in the process of solving the inquiry, the number of prompts sent to the second machine learning model equal to the number of steps required by the second machine learning model to solve the inquiry.

14. The non-transitory computer readable storage medium of claim 8, wherein the instructions are automatically generated from training materials.

15. A system for providing an automated agent, comprising:
one or more servers, wherein each server includes a memory and a processor; and
one or more modules stored in the memory and executed by at least one of the one or more processors to receive an inquiry from a customer by an automated agent on a first server, retrieving instructions, based on the inquiry, for the automated agent from a remote data store, determine, by a first machine learning model, which of the retrieved instructions are relevant to the inquiry, provide the inquiry, the instructions, and a role to a second machine learning model, the role indicating a service level associated with the automated agent, provide a response to the customer by the automated agent based on a response by the second machine learning model.

16. The system of claim 15, wherein the instructions are received from a vector database.

17. The system of claim 15, wherein the first machine learning model is a large language model.

18. The system of claim 17, wherein determining which of the retrieved instructions are relevant further includes:
constructing a prompt with the instructions, the inquiry, and a request to identify which of the retrieved instructions are relevant to satisfying the query; and
submitting the prompt to a large language model.

19. The system of claim 18, wherein the instructions provided to the second machine learning model are instructions determined to be relevant by the first large language model.

20. The system of claim 15, wherein the inquiry, the instructions, and the role are provided to the second machine learning model as a prompt, the one or more modules further executable to provide a plurality of prompts to the second large language model, each of the prompts including the inquiry, the instructions, the role, and a request to provide a single step in the process of solving the inquiry, the number of prompts sent to the second machine learning model equal to the number of steps required by the second machine learning model to solve the inquiry.

21. The system of claim 15, wherein the instructions are automatically generated from training materials.
